(19) United States
(12) Patent Application Publication
(10) Pub. No.: US 2013/0263176 A1
(43) Pub. Date: Oct. 3, 2013

(54) SHAREABLE CONTENT FOR PRESENTATION ON IPTV DEVICE WITH LOW-BANDWIDTH CONNECTION

(71) Applicants: True Xiong, San Diego, CA (US); Charles McCoy, Coronado, CA (US); Leo Mark Pedlow, JR., Ramona, CA (US); Jason Wallace, Encinitas, CA (US)

(72) Inventors: True Xiong, San Diego, CA (US); Charles McCoy, Coronado, CA (US); Leo Mark Pedlow, JR., Ramona, CA (US); Jason Wallace, Encinitas, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/432,734

(22) Filed: Mar. 28, 2012

(51) Int. Cl. H04N 21/25

(52) U.S. Cl. 725/31; 725/25

(57) ABSTRACT

Sharing content, including: enabling a second client device to access and retrieve the content from a shareable storage unit, wherein the content was downloaded by a first client device from a server using a first low-bandwidth Internet connection; receiving a request from the second client device for authentication and playing of the content; and authenticating to enable the second client device to play the content. Keywords include sharing content and shareable storage.

### BACKGROUND

1. Field of the Invention

The present invention relates to shareable content, and more specifically, to shareable content for presentation on an IPTV device with low-bandwidth connection.

2. Background

The Internet as a global network for delivery of content is increasing in popularity due to a number of technical advancements in broadband internet connectivity such as 3G and 4G, which creates both opportunities and challenges to content and service providers. Marketing research shows that the growth of Internet television (e.g., Internet Protocol television (IPTV)) will be in the developing countries such as China and India. However, network infrastructures in these developing countries are limited and undeveloped, and are unable to deliver quality content that require high bandwidth to customers.

### SUMMARY

In one implementation, a method of sharing content is disclosed. The method includes: enabling a second client device to access and retrieve the content from a portable and shareable storage unit, wherein the content was downloaded by a first client device from a server using a first low-bandwidth Internet connection; receiving a request from the second client device for authentication and playing of the content; and authenticating to enable the second client device to play the content.

In another implementation, a content sharing system is disclosed. The system includes: a shareable storage unit; a server in communication with a first client device, the server configured to download content to the first client device using a first low-bandwidth Internet connection, wherein the downloaded content is played on the first client device and is stored on the shareable storage unit, wherein the server receives a request from a second client device in communication with the server within a second low-bandwidth Internet connection, the second client device requesting to authenticate to present the content retrieved by the second client device from the shareable storage unit.

In another implementation, a non-transitory storage medium storing a computer program to enable sharing of content among client devices is disclosed. The computer program comprises executable instructions that cause a computer to: enable a second client device to access and retrieve the content from a shareable storage unit, wherein the content was downloaded by a first client device from a server using a first low-bandwidth Internet connection; receive a request from the second client device for authentication and presentation of the content; and authenticate to enable the second client device to present the content.

In another implementation, another method of sharing content is disclosed. The method includes: enabling a first client device to download a first segment of the content using a first low-bandwidth Internet connection and store the first segment in the shareable storage unit; enabling a second client device to download a second segment of the content using a second low-bandwidth Internet connection and store the second segment in the shareable storage unit; receiving requests from the first client device and the second client device for authentication and for playing the entire content, wherein the requests include information about all segments of the content; authenticating to enable the first client device and the second client device to play the entire content; and transmitting information regarding segment construction to the first client device and the second client device.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a functional block diagram of a content sharing system in accordance with one implementation of the present invention.

FIG. 2 is a flowchart illustrating a method of sharing contents to be played on an IPTV device in accordance with one implementation of the present invention.

FIG. 3A illustrates a representation of a computer system and a user.

FIG. 3B is a functional block diagram illustrating the computer system hosting a content authenticator.

### DETAILED DESCRIPTION

Certain implementations as disclosed herein describe apparatus, methods, and systems for an Internet Protocol television (IPTV) device targeting the low-bandwidth area in which content to be played on an IPTV device is shared. The term “content” is used here to generally refer to video and/or audio, but it may also refer to other contents such as image and application. However, this term can be used refer to anything that can be expressed through some medium, as speech, writing, or any of other forms of expression. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

As described above, marketing research shows that the IPTV will grow most in popularity in the developing countries such as China and India. However, network infrastructures in these developing countries are limited and undeveloped, and are unable to deliver quality content that require high bandwidth to customers. Therefore, an IPTV device configured to target the bandwidth range that is supported by these developing countries can be desirable. As an example, an average bandwidth in China and India is between 0.8 to 1 Mbits/sec (i.e., low-bandwidth connection), whereas an average bandwidth needed to play a high-definition movie is 6 Mbits/sec.

In one implementation, contents to be presented to the IPTV device (e.g., for viewing or play) are shared. For example, in rural areas of a developing country, a first customer with a first IPTV device may have downloaded content (e.g., most likely encrypted) overnight onto a shareable storage unit such as one of a non-volatile memory card, a flash memory, a memory stick drive, an optical disk, a hard disk of a laptop computer, and a storage unit of a mobile phone. It should be noted that the first IPTV device is a device authorized to stream or download the content. In one implementation, the first IPTV device can communicate with, for example, a streaming and on-demand service (hereinafter referred to as an “IPTV server”) such as the Bravia Internet Video Link (BIVL) system to download the content overnight. After the content has been downloaded onto the shareable storage unit, the first customer may first present the content to the first IPTV device to view the content. The first customer can also share, give to, exchange, or swap the content with friends, co-workers, or families.

A second customer (e.g., one of the friends, co-workers, or families living within the same rural area) with a second IPTV device wishes to watch the content but the bandwidth of the Internet connection prevents the second customer from streaming the content to the second IPTV device. It should be noted that the first customer and the second customer do not necessarily need to be living in the same house, and the first IPTV device and the second IPTV device do not need to be sharing the same Internet connection. In this case, the second customer can access the content downloaded by the first customer and stored on a shareable storage unit using the second IPTV device. In one implementation, the access to the content by the second customer is done by physically transferring the shareable storage unit from the first customer to the second customer.

In another implementation, the access to the content by the second customer is done by electronically transferring the content from the shareable storage unit to the second IPTV device through a local area network, for example, which has a higher bandwidth than that of the Internet connection. It should also be noted that the second IPTV device is a device authorized to stream or download the content. Thus, the second IPTV device which has obtained the content (most likely encrypted) from a shareable storage unit can communicate with the IPTV server to obtain an encryption key and play the content. The encryption key can be obtained based on subscription tier such as pay-per view or authentication application programming interface (API) which can authenticate the second IPTV device to the IPTV server. Another subscription type is per subscription for a week or month in which a user can view or play a set number of videos. After reaching this set number of videos, the subscription can be changed to pay per view or upgrade subscription type/level to unlimited view or play per week or month.

In an alternative implementation, each of the customers (e.g., more than one customer) downloads a different pre-agreed segment of the content using low-bandwidth Internet connections. Once all segments of the content have been downloaded and stored onto the shareable storage unit, when the user selects the first segment to play, the IPTV device sends a request to the server with information about all segments. When the IPTV device is authenticated, the server returns information regarding segment construction.

In another implementation, a method of sharing contents to be presented to an IPTV device is described. The method includes turning on the first IPTV device and connecting the device to the Internet. Once the first IPTV device is connected to the Internet, it launches an IPTV server. In an alternative, the first IPTV device can launch any service that would authenticate the device and allow it to select and download the content. In response, a list of recommended contents is returned and displayed to is the first customer in the local language. The first customer then selects a content item from the list of recommended contents for downloading onto the first IPTV device for presentation and onto the shareable storage unit for sharing the content. In one implementation, the selected content downloaded onto the shareable storage unit can be shared, given to, exchanged, or swapped with a second customer (e.g., a friend, co-worker, or family) who owns a second IPTV device. However, before the selected content can be played on the second IPTV device, the second IPTV device needs to be authenticated. To that end, the second IPTV device can launch the IPTV server. In an alternative, the second IPTV device can launch any service that would authenticate the device and allow it to play the selected content. The authentication can be based on a subscription rights or account permissions to present the selected content to the second IPTV device.

In another implementation, the sharing of the content to be presented to an IPTV device (using a shareable storage unit) can be extended to make the content available to other customers by rental for a fee. Again, before the selected content can be played on the IPTV device, the IPTV device needs to be authenticated or transacted.

In another implementation, a customer who obtains the content and desires to watch the content on the IPTV device, where the IPTV device is not authorized to play the content, an alternative or shorter version of the content can be displayed to the customer. For example, the IPTV server may display a message on the IPTV device indicating that the content cannot be presented or played on this device, but the IPTV server may allow the IPTV device to download and display a teaser, trailer, or any other short clip related to the content. The IPTV server may also encourage the customer to authenticate the IPTV device to present or play the content by signing up for a subscription service. In an alternative, the teaser, trailer, or any other short clip may reside as an encrypted content on the shareable storage unit such that the IPTV server can decrypt and activate the encrypted content to display the teaser, trailer, or any other short clip.

In yet another implementation, the content to be shared using the shareable storage unit is a free, high quality (HD) content. Again, the customers can share, give to, exchange, or swap the free content with friends, co-workers, families, or even with strangers. The playing of the free content can be subsidized with revenue from advertisement. For example, global advertisements can be added at the beginning of the original free content so that all customers who share the free content will see the same global advertisement. However, using the low-bandwidth Internet connection, the shareable storage unit connecting to the IPTV device can trigger the IPTV device to request the IPTV server to download the localized mid-roll and post-roll advertisements. Since these advertisements are relatively small in size compared to the size of the free content, the low-bandwidth Internet connection can be used to download the mid-roll and post-roll advertisements while the customer is viewing the free content. Thus, these mid-roll and post-roll advertisements can be dynamically inserted based on the region, locality, user heuristics or business rules. The free content on a mobile shareable storage unit can be used to promote businesses by distributing the shareable storage unit to clients and buyers. Businesses can advertise their goods and services while the clients and buyers, and their friends and families, can enjoy the free content subsidized by the advertisements.

In a further implementation, the concept of the free content with advertisement(s) added in can be extended further by tailoring the advertisement(s) to the customer currently watching the content rather than the customer who originally downloaded the content. For example, since advertisements are short, mid-roll and post-roll advertisements can be downloaded while the customer is viewing, listening, or otherwise interacting with the content. Since the IPTV server knows the profile of the customer currently watching the content, the mid-roll and post-roll advertisements can be specially tailored to target and are relevant to the current customer.

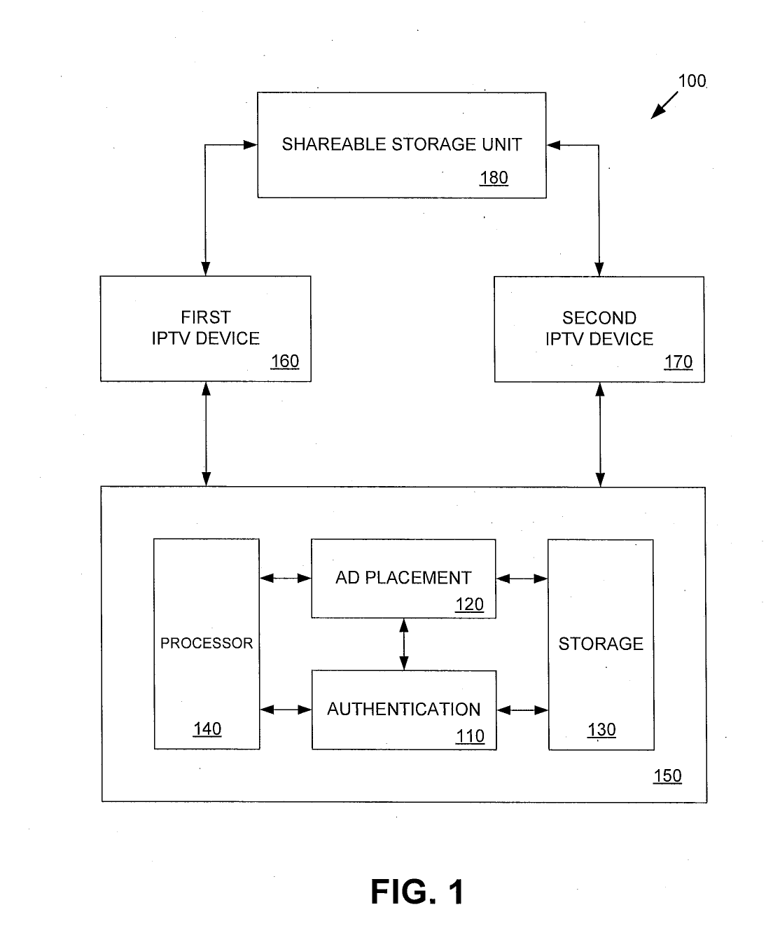

FIG. 1 is a functional block diagram of a content sharing system 100 in accordance with one implementation of the present invention. In the illustrated implementation of FIG. 1, the content sharing system 100 includes an IPTV server 150, a first IPTV device 160, a second IPTV device 170, and a shareable storage unit 180. Although FIG. 1 only shows two IPTV devices 160, 170, any number of IPTV devices can connect to the IPTV server 150, which includes an authentication unit 110, an advertisement placement unit 120, storage 130, and a processor 140. Further, an IPTV device can be generalized to a client device, and an IPTV server can be generalized to a server.

In one implementation, the IPTV server 150 is configured to provide streaming and on-demand services accessible through the IPTV device 160, 170, which can be configured to enable customers with the low-bandwidth Internet connection to share and play contents downloaded by other customers. For example, a first customer with the first IPTV device 160 may have downloaded encrypted content overnight onto the shareable storage unit 180 such as one of a non-volatile memory card, a flash memory, a memory stick drive, an optical disk, a hard disk of a laptop computer, and a storage unit of a mobile phone. After the content has been downloaded onto the shareable storage unit 180, the first customer can share, give to, exchange, or swap the content with friends, co-workers, or families.

A second customer with the second IPTV device 170 wishes to watch the content, but the bandwidth of the second customer's Internet connection prevents the second customer from streaming the content to the second IPTV device 170. In this case, the second customer can access the content downloaded by the first customer and stored on the shareable storage unit 180 using the second IPTV device 170. In one implementation, the access of the content by the second customer is done by physically transferring the shareable storage unit from the first customer to the second customer. In another implementation, the access of the content by the second customer is done by electronically transferring the content from the shareable storage unit 180 to the second IPTV device 170 through a local area network, for example, which has a higher bandwidth than that of the Internet connection. Thus, the second IPTV device 170 which has obtained the encrypted content from the shareable storage unit 180 can communicate with the IPTV server 150 to obtain an encryption key and play the content. The authentication unit 110 of the IPTV server 150 is configured to authenticate and provide an encryption key to the second IPTV device 170 so that the content can be played on the second IPTV device 170. The authentication and encryption key can be provided based on subscription tier such as pay-per-view or authentication application programming interface (API).

In an alternative implementation, each of the customers (e.g., more than one customer) downloads a different pre-agreed segment of the content using low-bandwidth Internet connections. Once all segments of the content have been downloaded and stored onto the shareable storage unit 180, when the user selects the first segment to play, the IPTV device 160, 170 sends a request to the server with information about all segments. When the IPTV device 160, 170 is authenticated, the server returns information regarding segment construction.

In another implementation, the content to be shared using the shareable storage unit 180 is a free, high definition (HD) content, and the customers can share, give to, exchange, or swap the free content with friends, co-workers, families, or even with strangers. In this implementation, the play of the free content can be subsidized with revenue from the advertisement. For example, the free content from the shareable storage unit 180 comes with global advertisements already added at the beginning so that all customers who share the free content will see the same global advertisement. The free content loaded onto the second IPTV device 170 also transmits a message to the advertisement placement unit 120 of the IPTV server 150 to download the localized mid-roll and post-roll advertisements. Since these advertisements are relatively small in size compared to the size of the free content, the low-bandwidth Internet connection can be used to download the mid-roll and post-roll advertisements while the customer is watching the free content on the second IPTV device 170. Thus, the advertisement placement unit 120 dynamically streams and inserts these mid-roll and post-roll advertisements based on the region, locality, user heuristics or business rules. The free content on a mobile shareable storage unit can be used to promote businesses by distributing the shareable storage unit to clients and buyers. Businesses can advertise their goods and services while the clients and buyers, and their friends and families, can enjoy the free content subsidized by the advertisements.

In a further implementation, the advertisement placement unit 120 of the IPTV server 150 extends the concept of the free content with advertisement(s) by tailoring the advertisement(s) to the customer currently watching the content rather than the customer who originally downloaded the content. Since the IPTV server 150 already knows the profile of the customer currently watching the content, the advertisement placement unit 120 can specially tailor the mid-roll and post-roll advertisements to target the current customer watching the free content.

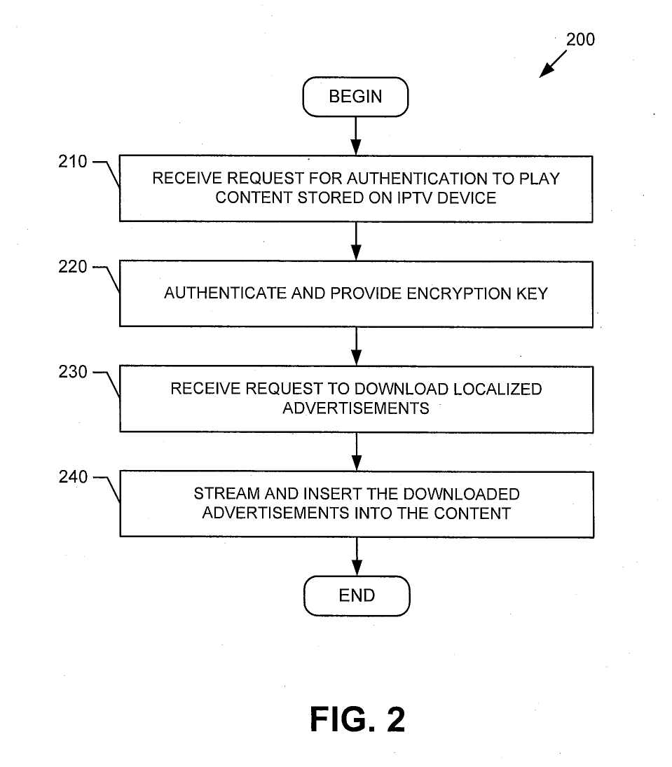

FIG. 2 is a flowchart 200 illustrating a method of sharing contents to be played on an IPTV device in accordance with one implementation of the present invention. The method includes turning on a first IPTV device and connecting the device to the Internet. Once the first IPTV device is connected to the Internet, it launches an IPTV server such as the BIVL system. In an alternative, the first IPTV device can launch any service that would authenticate the device and allow it to select and download the content. In response, a list of recommended contents is returned and displayed to the first customer in the local language. The first customer then selects a content item from the list of recommended contents for downloading onto a shareable storage unit.

A second customer with the second IPTV device 170 wishes to watch the content, but the bandwidth of the second customer's Internet connection prevents the second customer from streaming the content to the second IPTV device 170. In this case, the second customer accesses the content downloaded by the first customer and stored on the shareable storage unit 180 using the second IPTV device 170. In one implementation, the access of the content by the second customer is done by physically transferring the shareable storage unit from the first customer to the second customer. In another implementation, the access of the content by the second customer is done by electronically transferring the content from the shareable storage unit 180 to the second IPTV device 170 through a local area network, for example, which has a higher bandwidth than that of the Internet connection. Thus, the IPTV server 150 receives a request from the second IPTV device 170 for authentication and playing of the content, at box 210. Once the request is received, at box 210, the authentication unit 110 of the IPTV server 150 authenticates and provides an encryption key to the second IPTV device 170, at box 220, so that the content can be played on the second IPTV device 170. The authentication and encryption key can be provided based on subscription tier such as a pay-per-view or authentication application programming interface (API).

In another implementation, the playing of the content can be subsidized with revenue from advertisements. That is, instead of having a subscription or to authenticate to receive encryption key, the second IPTV device 170 can simply agrees to accept advertisements viewing the free content. For example, the content from the shareable storage unit 180 may come with global advertisements already added at the beginning so that all customers who share the content will see the same global advertisement. In this case, the IPTV server 150 receives a request to download localized advertisements, at box 230. Since these advertisements are relatively small in size compared to the size of the content, the low-bandwidth Internet connection can be used to download the mid-roll and post-roll advertisements while the customer is watching the content on the second IPTV device 170. In response, the IPTV server 150 dynamically streams and inserts the mid-roll and post-roll advertisements into the content, at box 240, based on the region, locality, user heuristics or business rules.

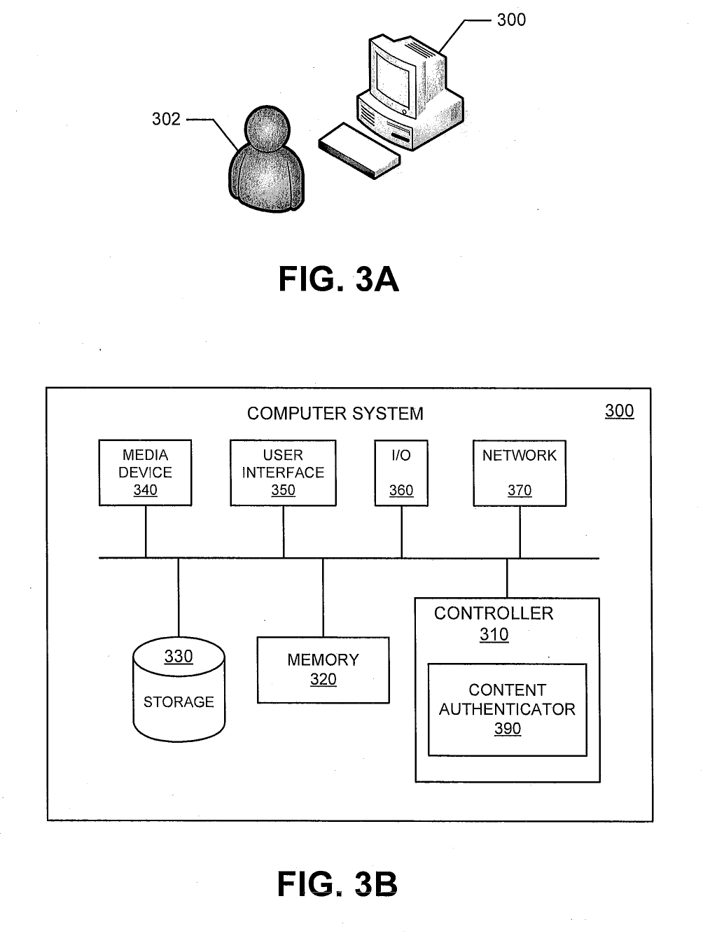

FIG. 3A illustrates a representation of a computer system 300 and a user 302. In one implementation, the computer system can be configured as an IPTV server (e.g., reference 150 in FIG. 1) configured to provide authentication for playing shared content on an IPTV device and advertisement placement.

FIG. 3B is a functional block diagram illustrating the computer system 300 hosting a content authenticator 390, which provides authentication for playing shared content on an IPTV device and advertisement placement. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the content authenticator 390 as a software system (running on the server 120 of FIG. 1). Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the content authenticator 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the agent 302 and presenting information to the agent 302. In one implementation, the user interface 350 includes a keyboard, a mouse, audio speakers, and a display. The controller 310 uses input from the agent 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as; USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, although the specification mentions only two IPTV devices, in real situation, a large number of IPTV devices may be involved. Thus, the two IPTV device examples can be extended to the multiple IPTV device examples. In another example, although each IPTV device is recited as using a separate low-bandwidth Internet connection, some IPTV devices can share the same low-bandwidth Internet connection. That is, the first IPTV device and the second IPTV device can access the server through the first low-bandwidth Internet connection. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of sharing content, the method comprising:
enabling a second client device to access and retrieve the content from a shareable storage unit,
wherein the content was downloaded by a first client device from a server using a first low-bandwidth Internet connection;
receiving a request from the second client device for authentication and playing of the content; and
authenticating to enable the second client device to play the content.

2. The method of claim 1, wherein authenticating is based on subscription tier such as a pay-per-view by the second client device.

3. The method of claim 1, wherein authenticating is based on an authentication application programming interface (API).

4. The method of claim 1, wherein authenticating comprises
providing an encryption key to play the content.

5. The method of claim 1, wherein authenticating comprises
receiving a request to download localized advertisements.

6. The method of claim 5, further comprising:
downloading the localized advertisements; and
inserting the localized advertisements while the content is playing on the second client device.

7. The method of claim 6, wherein downloading the localized advertisement comprises
downloading the localized advertisement using a second low-bandwidth Internet connection.

8. The method of claim 6, wherein downloading the localized advertisement comprises
tailoring the localized advertisement to a customer who owns the second client device.

9. The method of claim 1, wherein enabling a second client device to access and retrieve the content from a shareable storage unit comprises
electronically transferring the content from the shareable storage unit to the second client device through a local area network.

10. The method of claim 1, wherein enabling a second client device to access and retrieve the content from a shareable storage unit comprises
renting the shareable storage unit containing the content for a fee.

11. The method of claim 1, further comprising
presenting one of a teaser, trailer, or a short clip related to the content when the authentication fails.

12. The method of claim 1, further comprising
encouraging a customer who owns the second client device to sign up for a subscription service when the authentication fails.

13. A content sharing system, comprising:
a shareable storage unit;
a server in communication with a first client device, the server configured to download content to the first client device using a first low-bandwidth Internet connection,
wherein the downloaded content is played on the first client device and is stored on the shareable storage unit,
wherein the server receives a request from a second client device in communication with the server within a second low-bandwidth Internet connection, the second client device requesting to authenticate to present the content retrieved by the second client device from the shareable storage unit.

14. The system of claim 13, wherein the server comprises
an authentication unit configured to authenticate and provide an encryption key to the second client device.

15. The system of claim 14, wherein the authentication unit authenticates and provides an encryption key based on subscription by the second client device.

16. The system of claim 14, wherein the authentication unit authenticates and provides an encryption key based on an authentication application programming interface (API).

17. The system of claim 13, wherein each of the first client device and the second client device is an Internet Protocol television (IPTV) device.

18. The system of claim 13, wherein the shareable storage unit comprises one of a non-volatile memory card, a flash memory, a memory stick drive, an optical disk, a hard disk of a laptop computer, and a storage unit of a mobile phone.

19. The system of claim 13, wherein the server further comprises
an advertisement placement unit configured to download localized advertisement to the second client device while the second client device is playing the content retrieve from the shareable storage unit, and insert the localized advertisement into presentation of the content.

20. A non-transitory storage medium storing a computer program to enable sharing of content among client devices, the computer program comprising executable instructions that cause a computer to:
enable a second client device to access and retrieve the content from a shareable storage unit,
wherein the content was downloaded by a first client device from a server using a first low-bandwidth Internet connection;
receive a request from the second client device for authentication and presentation of the content; and
authenticate to enable the second client device to present the content.

21. A method of sharing content, the method comprising:
enabling a first client device to download a first segment of the content using a first low-bandwidth Internet connection and store the first segment in the shareable storage unit;
enabling a second client device to download a second segment of the content using a second low-bandwidth Internet connection and store the second segment in the shareable storage unit;
receiving requests from the first client device and the second client device for authentication and for playing the entire content,
wherein the requests include information about all segments of the content;
authenticating to enable the first client device and the second client device to play the entire content; and
transmitting information regarding segment construction to the first client device and the second client device.
